(19) United States
(12) Patent Application Publication
(10) Pub. No.: US 2026/0289305 A1
(43) Pub. Date: Sep. 24, 2026

(54) METHOD, APPARATUS, DEVICE AND PRODUCT FOR TRAINING MULTI-MODAL MODEL

(71) Applicant: Beijing Zitiao Network Technology Co., Ltd., Beijing (CN)

(72) Inventors: Yijie ZHENG, Beijing (CN); Bangjun XIAO, Beijing (CN); Lei SHI, Beijing (CN); Xiaoyang LI, Beijing (CN); Shouda LIU, Beijing (CN); Faming WU, Beijing (CN); Xuefeng XIAO, Beijing (CN)

(21) Appl. No.: 19/577,150

(22) Filed: Mar. 24, 2026

(30) Foreign Application Priority Data
Mar. 24, 2025 (CN) 202510352546.1

(51) Int. Cl. G06N 3/08; G06F 9/50

(52) U.S. Cl. CPC G06N 3/08; G06F 9/5027

(57) ABSTRACT

The present disclosure relates to a method, an apparatus, a device, and a product for training a multi-modal model. The method includes determining a plurality of batches for a plurality of dedicated accelerators obtained from a multi-modal dataset. The method includes reallocating the plurality of batches among the plurality of dedicated accelerators to obtain a plurality of reallocated batches. In addition, the method further includes training the multi-modal model in parallel using the plurality of reallocated batches.

### CROSS-REFERENCE TO RELATED APPLICATION(S)

This application claims priority to Chinese Application No. 202510352546.1 filed on Mar. 24, 2025, the disclosure of which is incorporated herein by reference in its entity.

### FIELD

The present disclosure relates to the field of computers and, in particular, to a method, an apparatus, a device and a product for training a multi-modal model.

### BACKGROUND

Large language models (LLMs) are important achievements in the field of artificial intelligence and are built using deep learning techniques. They learn language structure, semantics and grammar rules from massive text data, and are capable of generating coherent and logical text, and performing various natural language processing tasks such as text summarization, language translation, question answering, etc. With their strong language understanding and generation capabilities, LLMs are widely used in content creation, information retrieval, intelligent customer service and other scenarios, providing people with efficient and convenient language interaction services.

Multimodal large language models (MLLLMs) are advanced forms of LLMs that are capable of processing not only text, but also fusing information in multiple other modalities such as images, audio, video, etc. They break the limitations of single text information, allowing the models to learn from richer data sources and achieve cross-modal interaction and understanding. For example, descriptions may be provided based on image content, or complex instructions may be completed by combining speech and text information. Such models enable artificial intelligence with capabilities closer to human perception and cognition, and have great application potential in autonomous driving, virtual assistants, education and entertainment and other fields, promoting the development of artificial intelligence toward a more intelligent and general-purpose direction.

### SUMMARY

In a first aspect of embodiments of the present disclosure, a method for training a multi-modal model is provided. The method includes determining a plurality of batches for a plurality of dedicated accelerators obtained from a multi-modal dataset. The method includes reallocating the plurality of batches among the plurality of dedicated accelerators to obtain a plurality of reallocated batches. In addition, the method further includes training the multi-modal model in parallel using the plurality of reallocated batches.

In a second aspect of embodiments of the present disclosure, an apparatus for training a multi-modal model is provided. The apparatus includes a batch determination module configured to determine a plurality of batches for a plurality of dedicated accelerators obtained from a multi-modal dataset. The apparatus includes a batch reallocation module configured to reallocate the plurality of batches among the plurality of dedicated accelerators to obtain a plurality of reallocated batches. In addition, the apparatus further includes a parallel training module configured to train the multi-modal model in parallel using the plurality of reallocated batches.

In a third aspect of embodiments of the present disclosure, an electronic device is provided. The electronic device includes one or more processors; and a memory device for storing one or more programs, the one or more programs, when executed by the one or more processors, cause the one or more processors to implement a method for training a multi-modal model. The method includes determining a plurality of batches for a plurality of dedicated accelerators obtained from a multi-modal dataset. The method includes reallocating the plurality of batches among the plurality of dedicated accelerators to obtain a plurality of reallocated batches. In addition, the method further includes training the multi-modal model in parallel using the plurality of reallocated batches.

In a fourth aspect of embodiments of the present disclosure, a computer program product is provided. The computer program product is tangibly stored on a non-transitory computer-readable medium and includes machine-executable instructions that, when executed, cause a machine to implement a method for training a multi-modal model. The method includes determining a plurality of batches for a plurality of dedicated accelerators obtained from a multi-modal dataset. The method includes reallocating the plurality of batches among the plurality of dedicated accelerators to obtain a plurality of reallocated batches. In addition, the method further includes training the multi-modal model in parallel using the plurality of reallocated batches.

The Summary is to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The foregoing and other features, advantages and aspects of the embodiments of the present disclosure will become more apparent in combination with the drawings and with reference to the following detailed description. In the drawings, the same or similar reference numerals represent the same or similar elements, where:

FIG. 1 shows a schematic diagram of an example environment in which multiple embodiments of the present disclosure may be implemented;

FIG. 2 shows a flowchart of a method for training a multi-modal model according to some embodiments of the present disclosure;

FIG. 3 shows a schematic diagram of an example of a distributed training architecture for eliminating batch imbalance according to some embodiments of the present disclosure;

FIG. 4 shows a flowchart of a method for post-batch balancing without padding according to some embodiments of the present disclosure;

FIG. 5 shows a flowchart of a method for post-batch balancing with padding according to some embodiments of the present disclosure;

FIG. 6 shows a schematic diagram of an example of batch rearrangement through all-to-all communication according to some embodiments of the present disclosure;

FIG. 7 shows a schematic diagram of an example of a heterogeneous communication topology in a large-scale cluster for the distributed training shown in FIG. 3 according to some embodiments of the present disclosure;

FIG. 8 shows a flowchart of a method for node-level rearrangement after batch rearrangement according to some embodiments of the present disclosure;

FIG. 9 shows a process of an MLLM being trained using a multi-modal dataset according to some embodiments of the present disclosure;

FIG. 10 shows time consumed at various stages of parallel training for a multi-modal model executed on each DP instance according to some embodiments of the present disclosure;

FIG. 11 shows a block diagram of an apparatus for training a multi-modal model according to some embodiments of the present disclosure; and

FIG. 12 shows a block diagram of a device capable of implementing multiple embodiments of the present disclosure.

### DETAILED DESCRIPTION OF EMBODIMENTS

It may be understood that all user-related data involved in the technical solution should be acquired and used after user authorization. This means that in the technical solution, if it is necessary to use personal information of a user, explicit consent and authorization of the user are required before such data is acquired, otherwise, relevant data collection and use will not be performed. It should also be understood that when implementing the technical solution, relevant laws and regulations should be strictly complied with in the process of data collection, use and storage, and necessary technical means and measures should be taken to ensure user data security and secure data use.

It may be understood that before using the technical solution disclosed in the embodiments of the present disclosure, users should be informed of the type, range of use, use scenarios, etc., of personal information involved in the present disclosure in an appropriate manner in accordance with relevant laws and regulations, and user authorization should be obtained.

For example, when an active request of a user is received, prompt information is sent to the user to clearly inform the user that the requested operation will require access to and use of the user's personal information. As such, the user may independently choose, based on the prompt information, whether to provide the personal information to software or hardware, such as an electronic device, an application, a server or a storage medium, that performs operations of the technical solution of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It may be understood that the above process of notifying and obtaining user authorization is only illustrative and does not limit the implementations of the present disclosure. Other manners that satisfy relevant laws and regulations may also be applied in the implementations of the present disclosure.

The embodiments of the present disclosure will be described in more detail below with reference to the drawings. Although some embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are only for illustrative purposes and are not intended to limit the protection scope of the present disclosure.

In the description of the embodiments of the present disclosure, terms such as “include/comprise” and similar terms should be understood as open-ended inclusions, that is, “include/comprise but not limited to”. The term “based on” should be understood as “at least partially based on”. The term “one embodiment” or “the embodiment” should be understood as “at least one embodiment”. The terms “first”, “second”, etc. may refer to different or same objects, unless explicitly stated. Other explicit and implicit definitions may also be included below.

Data parallelism (DP) techniques are commonly adopted to train partition-distributed MLLMs on multiple devices. This is a technique that divides training data into multiple parts, which are allocated to multiple processing units (such as CPUs, GPUs, etc., also referred to herein as “DP instances”) for simultaneous processing. Due to the randomness of sequence lengths in a training dataset and the principle of batch (a subset of training data) randomization, the batch length may be regarded as a random variable. Therefore, each DP instance randomly samples small batches from the dataset, and the small batch lengths on different instances fluctuate greatly. This phenomenon is called small batch imbalance (or balance). In the model training stage, small batch imbalance may lead to many problems. First, during the synchronization communication between instances (any DP variant requires synchronization communication), an instance that processes a small batch length must wait for other instances to complete the synchronization operation.

To accelerate DP training, several methods have been proposed to solve the problem of small batch imbalance. Since all these methods perform balancing before small batches are generated, they are also collectively referred to as pre-balancing. A simple solution is to adopt a dynamic batch size, replacing a fixed batch size with an upper limit (or bound) on the batch length of a small batch. Improvements to this method include using more sophisticated algorithms to optimize the batching strategy, such as using several buckets to store data and performing batching when a bucket is full. Although these improvements enhance the balancing effect, they also violate the principle of batch randomization.

To this end, the present disclosure provides a method for training a multi-modal model. In the solution provided by the present disclosure, by reallocating batches obtained by multiple dedicated accelerators among the multiple dedicated accelerators and training the multi-modal model in parallel using reallocated batches, imbalance between batches is eliminated, utilization of the dedicated accelerators is improved, and the speed of model training is increased.

It should be understood that the technical solution of the present disclosure is implemented with permission of the relevant parties where permitted by laws and regulations. For example, in the field of model training, the technical solution is implemented with the right to use the training data.

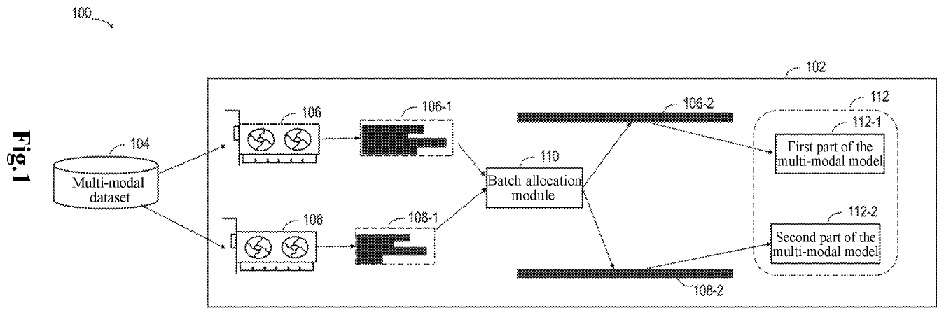

FIG. 1 shows a schematic diagram of an example environment 100 in which multiple embodiments of the present disclosure may be implemented. As shown in FIG. 1, the example environment 100 is a scenario in which a multi-modal model 112 is trained, which includes a multi-modal dataset 104 and a computing device 102. The multi-modal dataset 104 may include data in multiple modalities, such as text, images, video, audio, etc. The computing device 102 may include, but is not limited to, a personal computer, a server computer, a handheld or laptop device, a mobile device (such as a mobile phone, a personal digital assistant (PDA), a media player, etc.), a multi-processor system, a consumer electronic product, a wearable electronic device, a smart home device, a minicomputer, a mainframe computer, an edge computing device, a distributed computing environment including any of the above systems or devices, etc.

Dedicated accelerators 106 and 108 and a batch allocation module 110 are distributed on the computing device 102. In the environment 100, the dedicated accelerators 106 and 108 independently and separately obtain small batches from the multi-modal dataset 104, thereby obtaining a small batch 106-1 and a small batch 108-1, respectively. Each data item in the small batch 106-1 and the small batch 108-1 represents a sequence (or sample, example), and a length of the data item represents a sequence length that is closely related to consumption of computing resources and occupancy of storage space of batch processing. As shown in FIG. 1, it may be seen that a small batch includes multiple sequences, and before entering the batch allocation module 110, batch lengths of respective batches (the batches in FIG. 1 are not padded, and thus the batch length is a sum of lengths of respective sequences) deviate greatly. For example, the batch length of the small batch 106-1 is significantly longer than the batch length of the small batch 108-1.

The small batch 106-1 and the small batch 108-1 are reallocated by the batch allocation module 110, so that a batch length of a small batch 106-2 allocated to the dedicated accelerator 106 is almost the same as a batch length of a small batch 108-2 allocated to the dedicated accelerator 108. To avoid extra computational overhead (for example, increase in computation time) introduced by the allocation operation, a minimum splitting unit of the batch allocation module 110 is a sequence (that is, the data items in FIG. 1 will not be split), and the reallocation operation performed by the batch allocation module is to separate sequences in the small batches 106-1 and 108-1 that are initially collected, and form new small batches 106-2 and 108-2 that satisfy batch balance in a new combination manner. The new small batches 106-2 and 108-2 are provided to a first part 112-1 and a second part 112-2 of the multi-modal model that are deployed on the dedicated accelerators 106 and 108, respectively, to implement parallel training of the multi-modal model 112.

In this way, by recombining sequences of small batches across multiple dedicated accelerators to form new sequence combinations that satisfy batch balance, the phenomenon of small batch imbalance is eliminated, utilization of the dedicated accelerators is improved, and the speed of model training is increased.

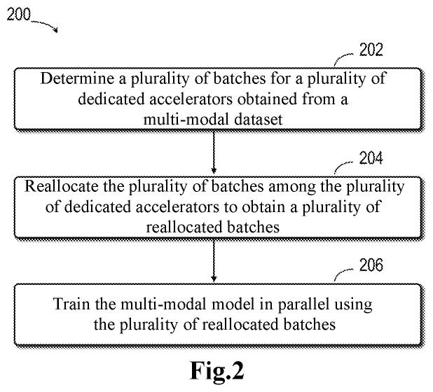

FIG. 2 shows a flowchart of a method 200 for training a multi-modal model according to some embodiments of the present disclosure. The method 200 may be performed in the computing device 102 shown in FIG. 1. The method 200 may further include additional operations not shown and/or may omit the operations shown, the order of the blocks shown in the figure may be changed, and the scope of the present disclosure will not be limited in this regard.

At block 202, a plurality of batches for a plurality of dedicated accelerators obtained from a multi-modal dataset are determined. For example, in the computing device 102 shown in FIG. 1, the small batches 106 and 108 are obtained from the multi-modal dataset 104 independently by the dedicated accelerators 106 and 108, respectively. In some embodiments, the dedicated accelerators 106 and 108 use a random number generator to generate random indices, which range from sample numbers of the multi-modal dataset 104 and the number of which is equal to the number of samples included in a small batch. Then samples are extracted from a data tensor based on these indices, to obtain a small batch.

At block 204, the plurality of batches are reallocated among the plurality of dedicated accelerators to obtain a plurality of reallocated batches. For example, in the computing device 102 shown in FIG. 1, the small batch 106-1 and the small batch 108-1 are reallocated between the dedicated accelerators 106 and 108 by the batch allocation module 110 with one sequence as the minimum splitting unit, to obtain a new small batch 106-2 and a new small batch 108-2 with almost equal batch lengths.

At block 206, the multi-modal model is trained in parallel using the plurality of reallocated batches. For example, in the computing device 102 shown in FIG. 1, the first part 112-1 and the second part 112-2 of the multi-modal model respectively deployed on the dedicated accelerators 106 and 108 are trained using the reallocated small batches 106-2 and 108-2, respectively. Since the batch lengths of the small batches 106-2 and 108-2 are almost equal, the dedicated accelerators 106 and 108 complete the training process almost at the same time, without the case where one party has to wait for the other to complete.

Through the method 200, the effect of batch balance is achieved after batches are formed without violating the principle of batch randomness, utilization of the dedicated accelerators is improved, and the speed of model training is increased.

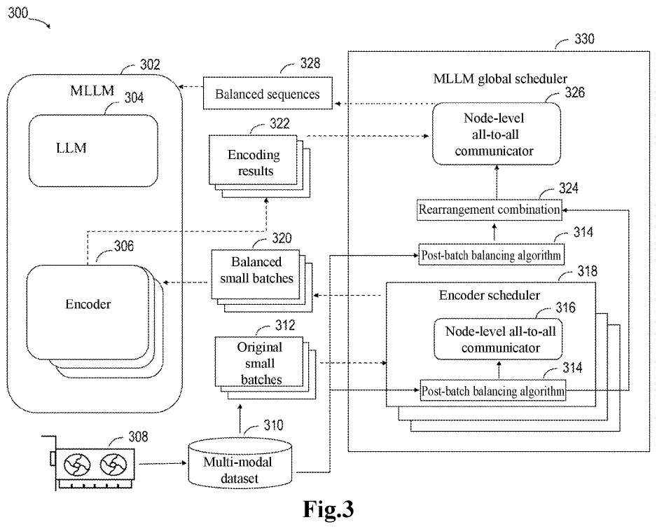

FIG. 3 shows a schematic diagram of a distributed training architecture 300 for eliminating batch imbalance according to some embodiments of the present disclosure. As shown in FIG. 3, the distributed training architecture 300 includes an MLLM 302, DP instances 308, a multi-modal dataset 310 and an MLLM global scheduler 330. The MLLM 302 includes an LLM 304 and an encoder 306. The encoder 306 may include a text encoder, an image encoder, an audio encoder, a video encoder, etc. The DP instances 308 may be, for example, one or more image processing units (GPUs), central processing units (CPUs), etc. The MLLM global scheduler 330 includes an encoder scheduler 318 and a node-level all-to-all communicator 326. The encoder scheduler 318 also includes a node-level all-to-all communicator 316. Dotted lines in FIG. 3 represent critical computation paths, and solid lines represent overlapping computation paths.

In the architecture 300, the encoder scheduler 318 is used to eliminate imbalance between small batches of the same modality, and the MLLM global scheduler 330 is used to eliminate imbalance caused by incoherence of modality combination, for example, there is a difference in proportional distribution of lengths of visual and auditory subsequences to a length of a combined sequence, which results in that a small batch on a DP instance may be in an idle state in one stage and in a straggler state in another stage. In addition, the MLLM global scheduler 330 overlaps computation of schedulers on non-critical paths (solid lines in the figure) to reduce the amount of computation.

In the architecture 300, the DP instances 308 randomly sample from the multi-modal dataset 310 to obtain original small batches 312, and the original small batches 312 are provided to the encoder scheduler 318. The encoder scheduler 318 transmits, through the node-level all-to-all communicator 316 across the DP instances 308, relevant information for batch rearrangement, and reallocates the original small batches 312 according to a rearrangement (also referred to as “reallocation”, “rearrangement” and “redistribution” herein) manner determined using the post-batch balancing algorithm 314, to obtain balanced small batches 320. The balanced small batches 320 satisfy that batch lengths between batches are equal or almost equal. In some embodiments, to reduce communication overhead, the original small batches 312 are not directly transmitted across the DPs 308, but lengths of the sequences are transmitted, because the only factor affecting the post-batch balancing algorithm 314 is the distribution of sequence lengths in the original small batches 312, and the communication overhead generated due to the transmission of only the sequence lengths is almost negligible.

In the architecture 300, the encoder 306 encodes the balanced small batches 320 to obtain encoding results 322. However, the encoding results 322 cannot be directly provided to the LLM 304, because the LLM training stage has additional data dependency, and the encoding results 322 from different encoders will be assembled and interleaved into a complete sequence as subsequences in a predefined order. If no balancing processing is performed on such reassembled interleaved sequences, the sequences are still unbalanced (i.e., the lengths of the interleaved sequences are different). Therefore, it is necessary to rearrange training data of all modalities using the MLLM global scheduler 330.

In the architecture 300, the encoding results 322 are provided to the MLLM global scheduler 330. The MLLM global scheduler 330 reallocates, through the node-level all-to-all communicator 326 across the DP instances 308 according to the rearrangement combination 324, subsequences of respective modalities in the encoding results 322 (represented by A_{E}_{ₖ}, where Eₖ represents the kth encoder), to obtain balanced sequences 328. The balanced sequences 328 are provided to the LLM 304 to perform parallel training for the multi-modal dataset 310 across the DP instances 308. The rearrangement combination 324 is a combination result of two rearrangement manners, one is a rearrangement manner of the modality k of the original small batches 312 for the encoding stage, represented by π_{E}_{ₖ}, and the other one is a rearrangement manner of all modalities of the original small batches 312 for the LLM training stage, represented by π_{M}, then a rearranged result A^{r}_{E}_{ₖ} of the encoding result for the modality k is represented as

$${A}_{{K}_{k}}^{′} = ( {Π}_{M} ◦ {Π}_{{E}_{k}}^{- 1} ) ( {A}_{{E}_{k}} ) \qquad ( 1 )$$

here

$${Π}_{M} ◦ {Π}_{{E}_{k}}^{- 1} \text{?}$$

$$\text{?} \text{indicates text missing or illegible when filed}$$

in the equation (1) is a rearrangement manner of the encoding result of the modality k in the encoding results 322, and the rearrangement manner of the encoding results of all the modalities constitutes the rearrangement combination 324.

Through the rearrangement combination 324, the two rearrangements that would otherwise be performed are applied to the encoding results 322 by combining them into a linear mapping, thereby avoiding performing all-to-all communication again, that is, the rearrangement combination 324 integrates two all-to-all communication operations for each encoder into one all-to-all communication operation in the forward pass. Since each rearrangement between the encoder 306 and the LLM is accompanied by a rearrangement of backward propagation, the communication overhead may be reduced by half, thereby increasing the speed of MLLM training.

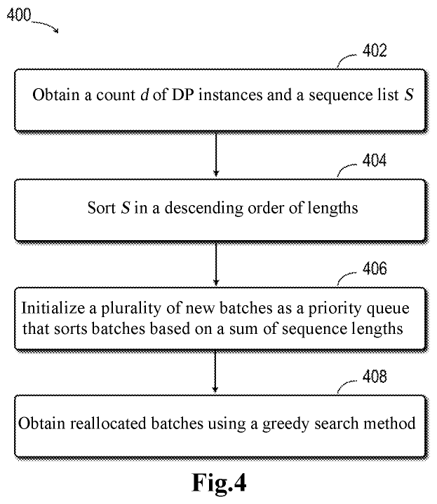

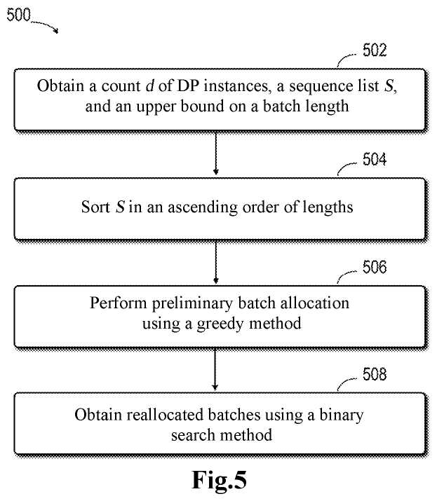

To further illustrate the distributed training architecture 300 shown in FIG. 3, the post-batch balancing algorithm is described below with reference to FIG. 4 to 5. Before the example methods 400 and 500 of the post-batch balancing algorithm are performed, it is necessary to determine a computing resource consumption function ƒ for each of the original small batches 312. For a model architecture (for example, a transformer architecture) in which a modality model has a self-attention mechanism and a multilayer encoder-decoder structure, the function ƒ may be expressed as

$$f ( {S}_{i} ) := \{ \begin{matrix}α {L}_{i} + \frac{1}{{b}_{1}} β {L}_{1}^{2} , \\ α {L}_{i} + β \text{?}\end{matrix} , \qquad ( 2 )$$

$$\text{?} \text{indicates text missing or illegible when filed}$$

here Sᵢ represents the ith small batch, Lᵢ represents a batch length of the ith small batch, l_{i,j} represents a sequence length of the jth sequence in the ith small batch, bᵢ represents the number of sequences in the ith small batch, and α and β are constants determined by characteristics of the model architecture itself.

For the case of padding sequences in a small batch, the function ƒ is the upper expression in the equation (2), and for the case of no padding, the function ƒ is the lower expression in the equation (2). The purpose of post-batch balancing is to minimize the maximum value of resource consumption values of respective batches. However, it is generally assumed that β is much smaller than α, therefore, whether it is a padding or non-padding case, for a model architecture in which a modality model has a self-attention mechanism and a multilayer encoder-decoder structure, the computing resource consumption may be approximately expressed as

$$f ( {S}_{i} ) := α {L}_{i} \qquad ( 3 )$$

FIG. 4 shows a flowchart of a method 400 for post-batch balancing without padding according to some disclosed embodiments. The post-batch balancing method 400 without padding may include the following operations in some embodiments. At block 402, parameters required by the algorithm are obtained, including a count d of DP instances and a sequence list S. At block 404, the sequence list S is sorted in a descending order of sequence lengths. This is to process longer sequences first, so that the lengths of respective batches may be better balanced when batches are subsequently divided. At block 406, a plurality of new batches are initialized as a priority queue that sorts batches based on a sum of sequence lengths, the number of the new batches being equal to the count d of DP instances. In this operation, a priority queue is created, and the priority queue is sorted according to the sum of sequence lengths in a batch, that is, a batch with a smaller sum of lengths is ranked higher. This helps to preferentially add a sequence to a batch with a smaller sum of lengths when a new sequence is added, so that the lengths of respective batches are as balanced as possible. At block 408, reallocated batches are obtained using a greedy algorithm. In this operation, each sequence in the sorted sequence list is traversed. For each sequence s, a batch at the top of the priority queue (that is, the batch with the smallest sum of lengths) is obtained, and then the current sequence s is added to this batch. This loop continues until all sequences are allocated to batches. Through the post-batch balancing method 400, relative balance of the sum of sequence lengths in each batch without padding is achieved.

FIG. 5 shows a flowchart of a method 500 for post-batch balancing in the case of padding according to some disclosed embodiments. The post-batch balancing method 500 in the case of padding may include the following operations in some embodiments. At block 502, parameters required by the algorithm are obtained, including the count d of DP instances, the sequence list S, and an initial value of an upper bound on a batch length. At block 504, the sequence list S is sorted in an ascending order of sequence lengths. At block 506, preliminary batch allocation is performed using a greedy algorithm. In this operation, for the current sequence s, it is checked whether adding it to the last batch would cause the batch length to exceed the initial value of the upper bound. If it exceeds, a new empty batch is created and the current sequence s is added to the new empty batch. At block 508, reallocated batches are obtained using binary search. In this operation, a proper upper bound on the batch length may be found by using the binary search method, so that the number of divided batches satisfies the count d of DP instances.

Compared with the pre-balancing method, the post-batch balancing methods described in the example methods 400 and 500 may obtain a batch rearrangement manner across DP instances, which does not violate the principle of batch randomness, and because load balancing is performed between small batches including all DP instances, not only a better balancing effect is achieved, the training speed is increased, and the utilization of the DP instances is maximized, but also redundant operations may be reduced. For example, the small batches 106 and 108 shown in FIG. 1 do not need to be padded to equal sequence lengths to perform subsequent processing.

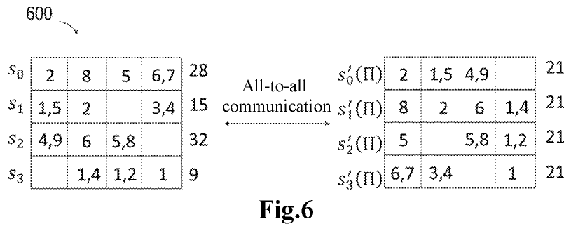

The node-level all-to-all communicators 316, 326 are described below with reference to FIGS. 6 to 8. FIG. 6 shows a schematic diagram of an example 600 of batch rearrangement through all-to-all communication according to some embodiments of the present disclosure. In FIG. 6, the original small batches 312 include batches S₁={2,5,6,7,8}, S₁={1,2,3,4,5}, S₂={4,5,6,8,9} and S₃={1,1,1,2,4}, where each number in a batch represents a length of a sequence, and the number of included numbers represents the number of sequences. It may be calculated that the batch lengths from S₀ to S₃ are 28, 15, 32 and 9, respectively, which is a very unbalanced distribution.

In some embodiments, the node-level all-to-all communicators 316, 326 include a plurality of communication manners. First, the length of each sequence is communicated between the DP instances 308 through an all-gather communication manner, then the rearrangement manner is determined by the post-batch balancing method, and the rearrangement according to the determined rearrangement manner is performed through all-to-all communication. In the all-gather communication, each participating process aggregates its own data into all processes. Assuming that there are P processes and each process has a portion of data, after the all-gather communication is performed, each process will have a data set of all the processes, that is, the final data of all the processes is the same. In the all-to-all communication, each process is allowed to send different data to all other processes. After the all-to-all communication is performed, each process will have a unique data set from all other processes, the data content of different processes may be different, and the communication overhead does not increase with the expansion of the cluster. By using the all-gather communication manner to communicate the sequence lengths before rearrangement and using the all-to-all communication manner to communicate the sequences during rearrangement, the communication overhead is greatly reduced, and no redundant memory needs to be allocated in the memory, which is more conducive to improving the memory utilization.

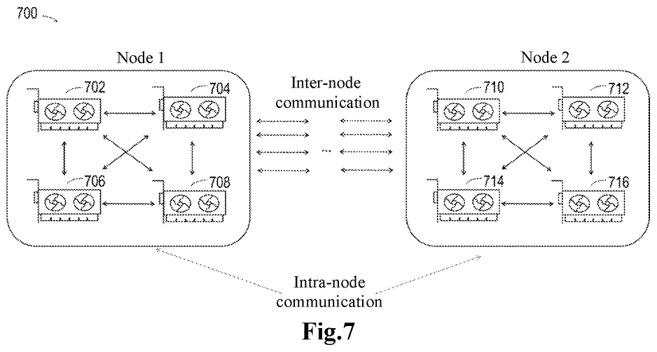

FIG. 7 shows a schematic diagram of an example 700 of a heterogeneous communication topology in a large-scale cluster for the distributed training shown in FIG. 3 according to some embodiments of the present disclosure. In FIG. 7, a DP instance 702, a DP instance 704, a DP instance 706 and a DP instance 708 are distributed on Node 1, and a DP instance 710, a DP instance 712, a DP instance 714 and a DP instance 716 are distributed on Node 2. There is a significant difference in communication bandwidth between communication between DP instances on the same node (that is, intra-node communication) and communication between DP instances on different nodes (that is, inter-node communication) when all-to-all communication is performed. For example, the intra-node communication using a high-performance, low-latency chip-to-chip high-speed interconnect communication technology, typically has a bandwidth of several hundred gigabytes, while the inter-node communication using Ethernet typically only allocates a bandwidth of several tens of gigabytes to each DP instance. The communication overhead of the node-level all-to-all communicators 316, 326 is determined by the maximum capacity of the intra-node communication, therefore, more traffic needs to be allocated to the intra-node communication to reduce the all-to-all communication overhead.

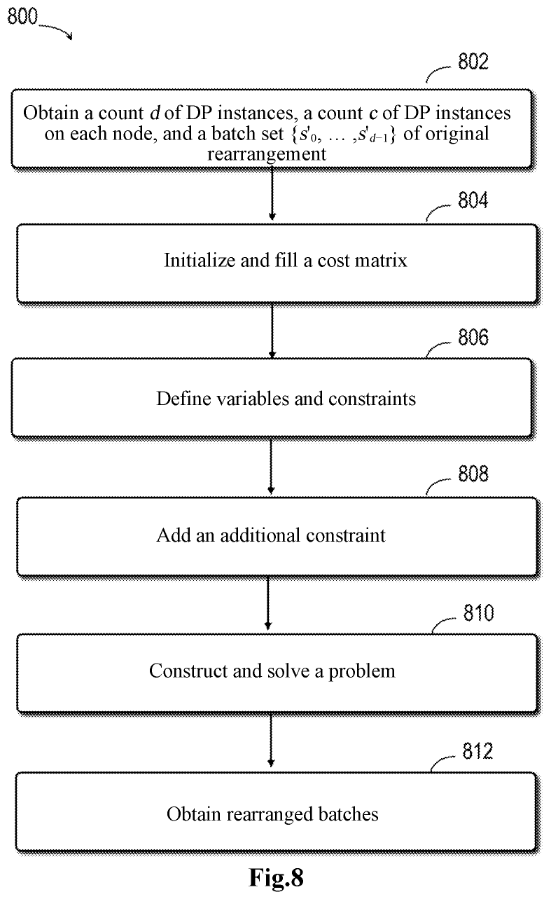

A method for reducing the all-to-all communication overhead is described below with reference to FIG. 8. FIG. 8 shows a flowchart of a method 800 for node-level rearrangement after batch rearrangement according to some embodiments of the present disclosure. The objective of the method 800 is to minimize the overhead allocated to the inter-node communication. The method 800 may include the following operations in some embodiments. At block 802, parameters required by the algorithm are obtained, including a count d of DP instances, a count c of DP instances on each node, and a batch set

$$\{ {S}_{0}^{r} , … , {S}_{d - 1}^{r} \}$$

of original rearrangement. At block 804, a cost matrix is initialized and filled. In this operation, a two-dimensional matrix of size d×d is created and the elements are initialized to 0, and this matrix is used to record the cost of sequence length from different source batches to a target batch. Each batch and the sequences in the batch are traversed through a loop, and the current sequence is filled in the corresponding position in the cost matrix. At block 806, variables and constraints are defined. In this operation, two variables are created, one variable x is related to node allocation in terms of dimension, and the range and meaning of values are related to d and c, and the other variable max_cost is used to record the maximum cost in the subsequent minimization operation. The constraint requires that the sum of each column of the variable x is equal to c and the sum of each row is equal to 1. At block 808, an additional constraint is added, the purpose of the additional constraint is to ensure that the maximum cost satisfies certain conditions when the batches are reallocated. At block 810, a problem is constructed and solved with an objective of minimizing max_cost. At block 812, rearranged batches are obtained. Through the method 800, more traffic may be allocated to the intra-node communication rather than the inter-node communication, thereby reducing the all-to-all communication overhead.

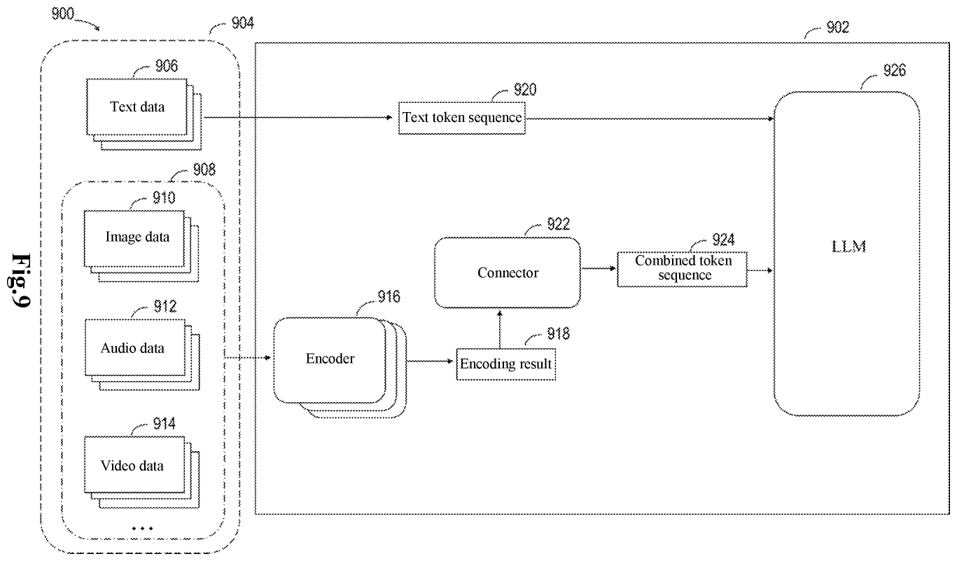

The training process of the MLLM is further described below with reference to FIG. 9. FIG. 9 shows a process 900 when an MLLM 902 performs training using a multi-modal dataset 904 according to some disclosed embodiments. As shown in FIG. 9, the MLLM 902 includes an encoder 916, a large LLM 926, and a connector 922 for connecting the encoder 916 to the LLM 926. For the modality dataset 904 to be used for training in the MLLM 902, the text data 906 therein does not need to be encoded, and only needs to be divided into text token sequences 920 to be provided to the LLM 926, while other non-text data 908, such as image data 910, audio data 912, video data 914, etc., needs to be encoded by the encoder 916 to obtain encoding results 918 provided to the connector 922, and then converted by the connector 922 into combined token sequences 924 arranged in a predefined order required by the LLM 926, before being provided to the LLM 926.

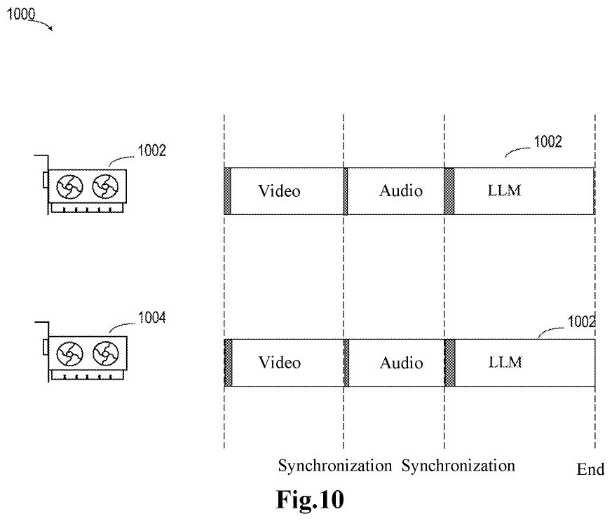

FIG. 10 shows time consumption of various stages of parallel training for a multi-modal model executed on each DP instance according to some disclosed embodiments. As shown in FIG. 10, whether it is the stage of processing video data, the stage of processing audio data, or the stage of performing LLM backbone training, each stage may be completed synchronously on each DP instance, and thus the entire training process on each DP instance also ends synchronously. FIG. 10 intuitively reflects that the combined use of the post-batch balancing method and the node-level all-to-all communicator according to the embodiments of the present disclosure may avoid various problems caused by batch imbalance, improve the memory utilization, and increase the speed of parallel training.

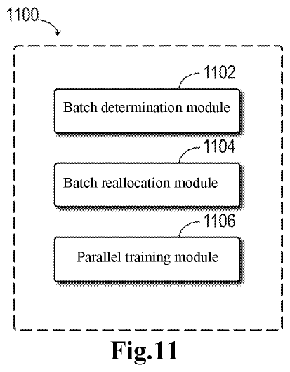

FIG. 11 shows a block diagram of an apparatus 1100 for training a multi-modal model according to some embodiments of the present disclosure. As shown in FIG. 11, the apparatus 1100 includes a batch determination module 1102 configured to determine a plurality of batches for a plurality of dedicated accelerators obtained from a multi-modal dataset. The apparatus 1100 further includes a batch reallocation module 1104 configured to reallocate the plurality of batches among the plurality of dedicated accelerators to obtain a plurality of reallocated batches. In addition, the apparatus 1100 further includes a parallel training module 1106 configured to train the multi-modal model in parallel using the plurality of reallocated batches.

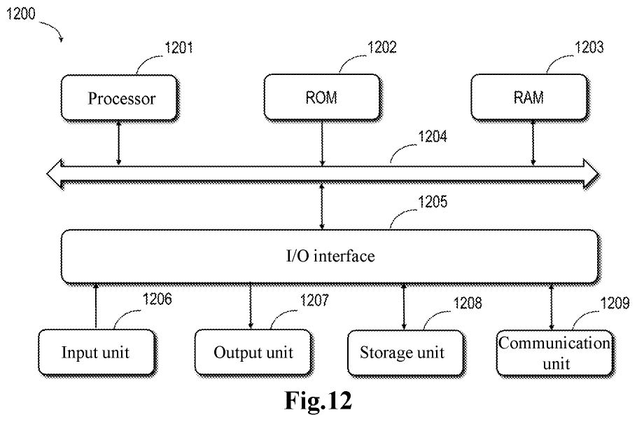

FIG. 12 shows a block diagram of a device 1200 capable of implementing multiple embodiments of the present disclosure. As shown in FIG. 10, the device 1200 includes a central processing unit (CPU) and/or a graphics processing unit (GPU) 1201, which may perform various appropriate actions and processing based on computer program instructions stored in a read-only memory (ROM) 1202 or computer program instructions loaded from a storage unit 1208 into a random access memory (RAM) 1203. The RAM 1203 may also store various programs and data required for operations of the device 1200. The CPU/GPU 1201, the ROM 1202 and the RAM 1203 are connected to each other through a bus 1204. An input/output (I/O) interface 1205 is also connected to the bus 1204. Although not shown in FIG. 10, the device 1200 may further include a coprocessor.

Multiple components in the device 1200 are connected to the I/O interface 1205, and the components include: an input unit 1206, such as a keyboard, a mouse, etc.; an output unit 1207, such as various types of displays, speakers, etc.; the storage unit 1208, such as a magnetic disk, an optical disc, etc.; and a communication unit 1209, such as a network card, a modem, a wireless communication transceiver, etc. The communication unit 1209 allows the device 1200 to exchange information/data with other devices over a computer network such as Internet and/or various telecommunication networks.

The various methods or processes described above may be performed by the CPU/GPU 1201. For example, in some embodiments, the method may be implemented as a computer software program, which is tangibly contained in a machine-readable medium, such as the storage unit 1208. In some embodiments, a portion or an entirety of the computer program may be loaded and/or installed into the device 1200 via the ROM 1202 and/or the communication unit 1209. When the computer program is loaded into the RAM 1203 and executed by the CPU/GPU 1201, one or more steps or actions in the method or process described above may be performed.

In some embodiments, the methods and processes described above may be implemented as a computer program product. The computer program product may include a computer-readable storage medium having computer-readable program instructions embodied thereon for performing various aspects of the present disclosure.

The computer-readable storage medium may be a tangible device that may hold and store instructions used by an instruction execution device. The computer-readable storage medium may be, for example, but not limited to, an electrical storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanically encoded device, such as a punch card or raised structures in a groove with instructions stored thereon, and any suitable combination of the foregoing. The computer-readable storage medium used herein is not interpreted as an instantaneous signal itself, such as a radio wave or other freely propagating electromagnetic wave, an electromagnetic wave propagating through a waveguide or other transmission medium (for example, a light pulse through an optical fiber cable), or an electrical signal transmitted through a wire.

The computer-readable program instructions described herein may be downloaded from the computer-readable storage medium to various computing/processing devices, or downloaded to an external computer or an external storage device through a network, such as Internet, a local area network, a wide area network, and/or a wireless network. The network may include a copper transmission cable, an optical fiber transmission, a wireless transmission, a router, a firewall, a switch, a gateway computer, and/or an edge server. A network adapter card or a network interface in each computing/processing device receives the computer-readable program instructions from the network and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, including object-oriented programming languages and conventional procedural programming languages. The computer-readable program instructions may be executed entirely on a user's computer, partly on the user's computer, as a stand-alone software package, partly on the user's computer and partly on a remote computer, or entirely on the remote computer or a server. In the case involving the remote computer, the remote computer may be connected to the user's computer through any kind of network, including a local area network (LAN) or a wide area network (WAN), or may be connected to an external computer (for example, connected through Internet with the aid of an Internet service provider). In some embodiments, by customizing an electronic circuit, such as a programmable logic circuit, a field programmable gate array (FPGA) or a programmable logic array (PLA), using status information of the computer-readable program instructions, the electronic circuit may execute the computer-readable program instructions, thereby implementing various aspects of the present disclosure.

These computer-readable program instructions may be provided to a processing unit of a general-purpose computer, a special-purpose computer, or other programmable data processing apparatus to produce a machine, such that when these instructions are executed by the processing unit of the computer or other programmable data processing apparatus, an apparatus for implementing the functions/actions specified in one or more blocks in the flowchart and/or block diagram is produced. These computer-readable program instructions may also be stored in the computer-readable storage medium, these instructions make the computer, the programmable data processing apparatus, and/or other devices work in a specific manner, and thus, the computer-readable medium storing the instructions includes a manufactured product, which includes instructions for implementing various aspects of the functions/actions specified in one or more blocks in the flowchart and/or block diagram.

The computer-readable program instructions may also be loaded onto a computer, other programmable data processing apparatus, or other device, so that a series of operation steps are performed on the computer, other programmable data processing apparatus, or other device to produce a computer-implemented process, such that the instructions executed on the computer, other programmable data processing apparatus, or other device implement the functions/actions specified in one or more blocks in the flowchart and/or block diagram.

The flowchart and block diagrams in the figures show the possibly implemented architectures, functions and operations of the device, the method and the computer program product according to multiple embodiments of the present disclosure. In this regard, each block in the flowchart or block diagram may represent a module, a program segment or a portion of instruction, which includes one or more executable instructions for implementing the specified logical functions. In some alternative implementations, the functions marked in the blocks may also occur in an order different from that marked in the figures. For example, two consecutive blocks may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or actions, or may be implemented by a combination of dedicated hardware and computer instructions.

The embodiments of the present disclosure have been described above, and the above description is exemplary, non-exhaustive, and not limited to the disclosed embodiments. Many modifications and variations will be apparent to those of ordinary skill in the art without departing from the scope and spirit of the illustrated embodiments. The terms used herein are chosen to best explain the principles of the embodiments, the practical application or the technical improvement to the technology in the market, or to enable other ordinary skilled persons in the art to understand the embodiments disclosed herein.

Some example implementations of the present disclosure are listed below.

Example 1. A method for training a multi-modal model, including:
determining a plurality of batches for a plurality of dedicated accelerators obtained from a multi-modal dataset;
reallocating the plurality of batches among the plurality of dedicated accelerators to obtain a plurality of reallocated batches; and
training the multi-modal model in parallel using the plurality of reallocated batches.

Example 2. The method according to Example 1, where reallocating the plurality of batches among the plurality of dedicated accelerators to obtain the plurality of reallocated batches includes:
obtaining a sequence length of each batch of a first modality in the multi-modal data through all-gather communication among the plurality of dedicated accelerators; and
performing reallocation on the plurality of batches of the first modality based on the sequence length.

Example 3. The method according to any one of Examples 1-2, where reallocating the plurality of batches among the plurality of dedicated accelerators to obtain the plurality of reallocated batches includes:
obtaining a sequence length of each batch of a second modality in the multi-modal data through all-to-all communication among the plurality of dedicated accelerators; and
performing reallocation on the plurality of batches of the second modality based on the sequence length.

Example 4. The method according to any one of Examples 1-3, where performing the reallocation on the plurality of batches of the first modality based on the sequence length includes:
determining training computing resource consumption for the plurality of batches based on the sequence length and a model architecture of the multi-modal model;
determining a corresponding reallocation manner based on the training computing resource consumption and a data organization manner of the plurality of batches; and
performing the reallocation on the plurality of batches of the first modality based on the reallocation manner.

Example 5. The method according to any one of Examples 1-4, where determining the training computing resource consumption for the plurality of batches based on the sequence length and the model architecture of the multi-modal model includes:
determining the training computing resource consumption for the plurality of batches based on the sequence length, a number of sequences in each of the plurality of batches, and a constant, in response to the multi-modal model using a model architecture with a self-attention mechanism and a multilayer encoder-decoder structure.

Example 6. The method according to any one of Examples 1-5, where determining the corresponding reallocation manner based on the training computing resource consumption and the data organization manner of the plurality of batches includes:
determining, using a greedy algorithm, a reallocation manner that minimizes a largest training computing resource consumption in the training computing resource consumption of the plurality of batches, in response to the data organization manner of the plurality of batches being a non-padding mode; or
determining, using a combination of binary search and a greedy algorithm, a reallocation manner that minimizes the largest training computing resource consumption in the training computing resource consumption of the plurality of batches, in response to the data organization manner of the plurality of batches being a padding mode.

Example 7. The method according to any one of Examples 1-6, where performing the reallocation on the plurality of batches of the first modality based on the reallocation manner includes:
performing, through all-to-all communication among the plurality of dedicated accelerators, reallocation according to the reallocation manner on the plurality of batches of each modality; and
performing node-level reallocation on the plurality of reallocated batches.

Example 8. The method of any of Examples 1-7, performing the node-level reallocation based on the plurality of reallocated batches includes:
determining, based on a number of the dedicated accelerators, a number of the dedicated accelerators located on a node, and the plurality of reallocated batches, a reallocation manner that minimizes communication traffic among nodes; and
performing the reallocation on the plurality of reallocated batches based on the reallocation manner.

Example 9. The method of any of Examples 1-8, training the multi-modal model in parallel using the reallocated batches includes:
encoding the plurality of reallocated batches to obtain encoding results for the batches;
determining a reallocation manner for the encoding results; and
train the multi-modal model in parallel by reallocating the encoding results based on the reallocation manner to.

Example 10. The method of any of Examples 1-9, determining the reallocation manner for the encoding results includes:
determining a first reallocation manner for a large language model backbone network;
determining a second reallocation manner of mapping the encoding results back to an original dedicated accelerator; and
combining the first reallocation manner and the second reallocation manner into a linear mapping as the reallocation manner for the encoding results.

Example 11. An apparatus for training a multi-modal model, including:
a batch determination module, configured to determine a plurality of batches for a plurality of dedicated accelerators obtained from a multi-modal dataset;
a batch reallocation module, configured to reallocate the plurality of batches among the plurality of dedicated accelerators to obtain a plurality of reallocated batches; and
a parallel training module, configured to train the multi-modal model in parallel using the plurality of reallocated batches.

Example 12. The apparatus of any of Examples 10-11, wherein the batch reallocation module includes:
a first communication module, configured to obtain a sequence length of each batch of a first modality in the multi-modal data through all-gather communication among the plurality of dedicated accelerators; and
a first batch rearrangement module, configured to perform the reallocation on the plurality of batches of the first modality based on the sequence length.

Example 13. The apparatus of any of Examples 10-12, wherein the batch reallocation module includes:
a second communication module, configured to obtain a sequence length of each batch of a second modality in the multi-modal data through all-to-all communication among the plurality of dedicated accelerators; and
a second batch rearrangement module, configured to perform the reallocation on the plurality of batches of the second modality based on the sequence length.

Example 14. The apparatus of any of Examples 10-13, wherein the first batch rearrangement module includes:
a computing module, configured to determine training computing resource consumption for the plurality of batches based on the sequence length and a model architecture of the multi-modal model;
an allocation manner determination module, configured to determine a corresponding reallocation manner based on the training computing resource consumption and a data organization manner of the plurality of batches; and
an allocation execution module, configured to perform the reallocation on the plurality of batches of the first modality based on the reallocation manner.

Example 15. The apparatus of any of Examples 10-14, wherein the computing module includes:
a resource consumption determination module, configured to, determine the training computing resource consumption for the plurality of batches based on the sequence length, a number of sequences in each of the plurality of batches, and a constant in response to the multi-modal model adopting a model architecture with a self-attention mechanism and a multilayer encoder-decoder structure.

Example 16. The apparatus of any of Examples 10-15, wherein the allocation manner determination module includes:
a first reallocation determination module, configured to, determine, using a greedy algorithm, a reallocation manner that minimizes a largest training computing resource consumption in the training computing resource consumption of the plurality of batches, in response to the data organization manner of the plurality of batches being a non-padding mode; or
a second reallocation determination module, configured to, determine, using a combination of binary search and a greedy algorithm, a reallocation manner that minimizes the largest training computing resource consumption in the training computing resource consumption of the plurality of batches, in response to the data organization manner of the plurality of batches being a padding mode.

Example 17. The apparatus of any of Examples 10-16, wherein the allocation execution module includes:
a first allocation execution module, configured to perform, through all-to-all communication among the plurality of dedicated accelerators, reallocation according to the reallocation manner on the plurality of batches of each modality; and
a node-level allocation execution module, configured to perform node-level reallocation on the plurality of reallocated batches.

Example 18. The apparatus of any of Examples 10-17, wherein the node-level allocation execution module includes:
a rearrangement determination module, configured to determine, based on a number of the dedicated accelerators, a number of the dedicated accelerators located on a node, and the plurality of reallocated batches, a rearrangement manner that minimizes communication traffic among nodes; and
a rearrangement execution module, configured to perform reallocation on the plurality of reallocated batches based on the rearrangement manner.

Example 19. The apparatus of any of Examples 10-18, wherein the parallel training module includes:
an encoding module, configured to encode the reallocated batches to obtain encoding results for the batches;
an encoding result rearrangement manner determination module, configured to determine a reallocation manner for the encoding results; and
an encoding result rearrangement execution module, configured to rearrange the encoding results based on the reallocation manner to train the multi-modal model in parallel.

Example 20. The apparatus of any of Examples 10-19, wherein the encoding result rearrangement manner determination module includes:
a first reallocation manner determination module, configured to determine a first rearrangement manner for a large language model backbone network;
a second reallocation manner determination module, configured to determine a second rearrangement manner of mapping the encoding results back to an original dedicated accelerator; and
a reallocation manner combination module, configured to combine the first reallocation manner and the second reallocation manner into a linear mapping as the reallocation manner for the encoding results.

Example 21. An electronic device, including:
a processor; and
a memory coupled with the processor, the memory having instructions stored therein, the instructions, when executed by the processor, causing the electronic device to perform actions, the actions including:
determining a plurality of batches for a plurality of dedicated accelerators obtained from a multi-modal dataset;
reallocating the plurality of batches among the plurality of dedicated accelerators to obtain a plurality of reallocated batches; and
training the multi-modal model in parallel using the plurality of reallocated batches.

Example 22. The electronic device of Example 21, wherein reallocating the plurality of batches among the plurality of dedicated accelerators to obtain a plurality of reallocated batches includes:
obtaining a sequence length of each batch of a first modality in the multi-modal data through all-gather communication among the plurality of dedicated accelerators; and
performing reallocation on the plurality of batches of the first modality based on the sequence length.

Example 23. The electronic device of any of Examples 21-22, wherein reallocating the plurality of batches among the plurality of dedicated accelerators to obtain a plurality of reallocated batches includes:
obtaining a sequence length of each batch of a second modality in the multi-modal data through all-to-all communication among the plurality of dedicated accelerators; and
performing reallocation on the plurality of batches of the second modality based on the sequence length.

Example 24. The electronic device of any of Examples 21-23, wherein performing reallocation on the plurality of batches of the first modality based on the sequence length includes:
determining training computing resource consumption for the plurality of batches based on the sequence length and a model architecture of the multi-modal model;
determining a corresponding reallocation manner based on the training computing resource consumption and a data organization manner of the plurality of batches; and
performing the reallocation on the plurality of batches of the first modality based on the reallocation manner.

Example 25. The electronic device of any of Examples 21-24, wherein determining training computing resource consumption for the plurality of batches based on the sequence length and a model architecture of the multi-modal model includes:
determining the training computing resource consumption for the plurality of batches based on the sequence length, a number of sequences in each of the plurality of batches, and a constant, in response to the multi-modal model using a model architecture with a self-attention mechanism and a multilayer encoder-decoder structure.

Example 26. The electronic device of any of Examples 21-25, wherein determining a corresponding reallocation manner based on the training computing resource consumption and a data organization manner of the plurality of batches includes:
determining, using a greedy algorithm, a reallocation manner that minimizes a largest training computing resource consumption in the training computing resource consumption of the plurality of batches, in response to the data organization manner of the plurality of batches being a non-padding mode; or
determining, using a combination of binary search and a greedy algorithm, a reallocation manner that minimizes a largest training computing resource consumption in the training computing resource consumption of the plurality of batches, in response to the data organization manner of the plurality of batches being a padding mode.

Example 27. The electronic device of any of Examples 21-26, wherein performing the reallocation on the plurality of batches of the first modality based on the reallocation manner includes:
performing, through all-to-all communication among the plurality of dedicated accelerators, reallocation according to the reallocation manner on the plurality of batches of each modality; and
performing node-level reallocation on the plurality of reallocated batches.

Example 28. The electronic device of any of Examples 21-27, wherein performing node-level reallocation on the plurality of reallocated batches includes:
determining, based on a number of the dedicated accelerators, a number of the dedicated accelerators located on a node, and the plurality of reallocated batches, a rearrangement manner that minimizes communication traffic between nodes; and
performing reallocation on the plurality of reallocated batches based on the rearrangement manner.

Example 29. The electronic device of any of Examples 21-28, wherein training the multi-modal model in parallel using the reallocated batches includes:
encoding the reallocated batches to obtain encoding results for the batches;
determining a reallocation manner for the encoding results; and
rearranging the encoding results based on the reallocation manner to train the multi-modal model in parallel.

Example 30. The electronic device of any of Examples 21-29, wherein determining a reallocation manner for the encoding results includes:
determining a first reallocation manner for a large language model backbone network;
determining a second reallocation manner of mapping the encoding results back to an original dedicated accelerator; and
combining the first reallocation manner and the second rearrangement manner into a linear mapping as the reallocation manner for the encoding results.

Example 31. A computer-readable storage medium having computer-executable instructions stored thereon, wherein the computer-executable instructions are executed by a processor to implement the method according to any one of Examples 1-10.

Example 32. A computer program product tangibly stored on a computer-readable medium and including computer-executable instructions, the computer-executable instructions, when executed by a device, causing the device to perform the method according to any one of Examples 1-10.

Although the present disclosure has been described in language specific to structural features and/or logical actions of the method, it should be understood that the subject matter defined in the appended claims is not necessarily limited to the specific features or actions described above. Rather, the specific features and actions described above are merely example forms for implementing the claims.

I/We claim:

1. A method for training a multi-modal model, comprising:
determining a plurality of batches for a plurality of dedicated accelerators obtained from a multi-modal dataset;
reallocating the plurality of batches among the plurality of dedicated accelerators to obtain a plurality of reallocated batches; and
training the multi-modal model in parallel using the plurality of reallocated batches.

2. The method of claim 1, wherein reallocating the plurality of batches among the plurality of dedicated accelerators to obtain the plurality of reallocated batches comprises:
obtaining a sequence length of each batch of a first modality in multi-modal data through all-gather communication among the plurality of dedicated accelerators; and
performing reallocation on the plurality of batches of the first modality based on the sequence length.

3. The method of claim 2, wherein reallocating the plurality of batches among the plurality of dedicated accelerators to obtain the plurality of reallocated batches further comprises:
obtaining a sequence length of each batch of a second modality in the multi-modal data through all-gather communication among the plurality of dedicated accelerators; and
performing reallocation on the plurality of batches of the second modality based on the sequence length.

4. The method of claim 2, wherein performing the reallocation on the plurality of batches of the first modality based on the sequence length comprises:
determining training computing resource consumption for the plurality of batches based on the sequence length and a model architecture of the multi-modal model;
determining a corresponding reallocation manner based on the training computing resource consumption and a data organization manner of the plurality of batches; and
performing the reallocation on the plurality of batches of the first modality based on the reallocation manner.

5. The method of claim 4, wherein determining the training computing resource consumption for the plurality of batches based on the sequence length and the model architecture of the multi-modal model comprises:
determining the training computing resource consumption for the plurality of batches, based on the sequence length, a number of sequences in each batch of the plurality of batches, and a constant, in response to the multi-modal model using a model architecture with a self-attention mechanism and a multilayer encoder-decoder structure.

6. The method of claim 4, wherein determining the corresponding reallocation manner based on the training computing resource consumption and the data organization manner of the plurality of batches comprises:
determining, using a greedy algorithm, a reallocation manner that minimizes a largest training computing resource consumption in the training computing resource consumption of the plurality of batches, in response to the data organization manner of the plurality of batches being a non-padding mode; or
determining, using a combination of binary search and a greedy algorithm, a reallocation manner that minimizes the largest training computing resource consumption in the training computing resource consumption of the plurality of batches, in response to the data organization manner of the plurality of batches being a padding mode.

7. The method of claim 4, wherein performing the reallocation on the plurality of batches of the first modality based on the reallocation manner comprises:
performing, through all-to-all communication among the plurality of dedicated accelerators, reallocation according to the reallocation manner on the plurality of batches of each modality; and
performing node-level reallocation on the plurality of reallocated batches.

8. The method of claim 7, wherein performing the node-level reallocation on the plurality of reallocated batches comprises:
determining, based on a number of the dedicated accelerators, a number of the dedicated accelerators located on a node, and the plurality of reallocated batches, a reallocation manner that minimizes communication traffic among nodes; and
performing the reallocation on the plurality of reallocated batches based on the reallocation manner, wherein the plurality of batches are obtained through random sampling by the plurality of dedicated accelerators.

9. The method of claim 1, wherein training the multi-modal model in parallel using the plurality of reallocated batches comprises:
encoding the plurality of reallocated batches to obtain an encoding result for the plurality of batches;
determining a reallocation manner for the encoding result; and
training the multi-modal model in parallel by reallocating the encoding result based on the reallocation manner.

10. The method of claim 9, wherein determining the reallocation manner for the encoding result comprises:
determining a first reallocation manner for a large language model training stage;
determining a second reallocation manner of mapping the encoding result back to an original dedicated accelerator; and
combining the first reallocation manner and the second reallocation manner into a linear mapping as the reallocation manner for the encoding result.

11. An electronic device, comprising:
a processor; and
a memory coupled to the processor, the memory having instructions stored therein, wherein the instructions, when executed by the processor, cause the electronic device to:
determine a plurality of batches for a plurality of dedicated accelerators obtained from a multi-modal dataset;
reallocate the plurality of batches among the plurality of dedicated accelerators to obtain a plurality of reallocated batches; and
train the multi-modal model in parallel using the plurality of reallocated batches.

12. The electronic device of claim 11, wherein the instructions causing the processor to reallocate the plurality of batches among the plurality of dedicated accelerators to obtain the plurality of reallocated batches comprise instructions to:
obtain a sequence length of each batch of a first modality in multi-modal data through all-gather communication among the plurality of dedicated accelerators; and
perform reallocation on the plurality of batches of the first modality based on the sequence length.

13. The electronic device of claim 12, wherein the instructions causing the processor to reallocate the plurality of batches among the plurality of dedicated accelerators to obtain the plurality of reallocated batches further comprise instructions to:
obtain a sequence length of each batch of a second modality in the multi-modal data through all-gather communication among the plurality of dedicated accelerators; and
perform reallocation on the plurality of batches of the second modality based on the sequence length.

14. The electronic device of claim 12, wherein the instructions causing the processor to performing the reallocation on the plurality of batches of the first modality based on the sequence length comprise instructions to:
determine training computing resource consumption for the plurality of batches based on the sequence length and a model architecture of the multi-modal model;
determine a corresponding reallocation manner based on the training computing resource consumption and a data organization manner of the plurality of batches; and
perform the reallocation on the plurality of batches of the first modality based on the reallocation manner.

15. The electronic device of claim 14, wherein the instructions causing the processor to determine the training computing resource consumption for the plurality of batches based on the sequence length and the model architecture of the multi-modal model comprise instructions to:
determine the training computing resource consumption for the plurality of batches, based on the sequence length, a number of sequences in each batch of the plurality of batches, and a constant, in response to the multi-modal model using a model architecture with a self-attention mechanism and a multilayer encoder-decoder structure.

16. The electronic device of claim 14, wherein the instructions causing the processor to determine the corresponding reallocation manner based on the training computing resource consumption and the data organization manner of the plurality of batches comprise instructions to:
determine, using a greedy algorithm, a reallocation manner that minimizes a largest training computing resource consumption in the training computing resource consumption of the plurality of batches, in response to the data organization manner of the plurality of batches being a non-padding mode; or
determine, using a combination of binary search and a greedy algorithm, a reallocation manner that minimizes the largest training computing resource consumption in the training computing resource consumption of the plurality of batches, in response to the data organization manner of the plurality of batches being a padding mode.

17. The electronic device of claim 14, wherein the instructions causing the processor to perform the reallocation on the plurality of batches of the first modality based on the reallocation manner comprise instructions to:
perform, through all-to-all communication among the plurality of dedicated accelerators, reallocation according to the reallocation manner on the plurality of batches of each modality; and
perform node-level reallocation on the plurality of reallocated batches.

18. The electronic device of claim 17, wherein the instructions causing the processor to perform the node-level reallocation on the plurality of reallocated batches comprise instructions to:
determine, based on a number of the dedicated accelerators, a number of the dedicated accelerators located on a node, and the plurality of reallocated batches, a reallocation manner that minimizes communication traffic among nodes; and
perform the reallocation on the plurality of reallocated batches based on the reallocation manner, wherein the plurality of batches are obtained through random sampling by the plurality of dedicated accelerators.

19. The electronic device of claim 11, wherein the instructions causing the processor to train the multi-modal model in parallel using the plurality of reallocated batches comprise instructions to:
encode the plurality of reallocated batches to obtain an encoding result for the plurality of batches;
determine a reallocation manner for the encoding result; and
train the multi-modal model in parallel by reallocating the encoding result based on the reallocation manner.

20. A computer program product, tangibly stored on a non-transitory computer-readable medium and comprising machine-executable instructions, the machine-executable instructions, when executed, cause a machine to:
determine a plurality of batches for a plurality of dedicated accelerators obtained from a multi-modal dataset;
reallocate the plurality of batches among the plurality of dedicated accelerators to obtain a plurality of reallocated batches; and
train the multi-modal model in parallel using the plurality of reallocated batches.
